(19) United States
(12) Patent Application Publication
(10) Pub. No.: US 2016/0298385 A1
(43) Pub. Date: Oct. 13, 2016

(54) BLIND BODY BRAKE MECHANISM FOR NON PULL CORD WINDOW BLIND

(71) Applicant: Chin-Fu CHEN, Taichung City (TW)

(72) Inventor: Po-Yu CHEN, Taichung City (TW)

(21) Appl. No.: 15/089,032

(22) Filed: Apr. 1, 2016

(30) Foreign Application Priority Data
Apr. 8, 2015 (TW) 104111192

(51) Int. Cl. E06B 9/322; E06B 9/324

(52) U.S. Cl. CPC E06B 9/322; E06B 9/324

(57) ABSTRACT

A window body brake mechanism for non pull cord window blind includes two one-way clutch units for controlling the movement of two transmission cords respectively. The one-way clutch unit includes a wheel axle holder, a clutch wheel axle fixedly mounted in the wheel axle holder and having a plurality of brake blocks equiangularly spaced around one end thereof and a rolling groove defined between each two adjacent brake blocks, a clutch wheel rotatably mounted on the clutch wheel axle and having an internal gear located therein around the brake blocks, and a plurality of planetary gears rotatably mounted in one respective rolling groove and meshed with the internal gear of the clutch wheel. Thus, the planetary gears are drivable by the internal gear of the clutch wheel into engagement with the respective brake blocks of the clutch wheel axle or away therefrom.

### BACKGROUND OF THE INVENTION

1. Field of the Invention

The present invention relates to window blind technology, and more particularly to a blind body brake mechanism for non pull cord window blind.

2. Description of the Related Art

Commercial window blinds can be classified into pull-cord window blinds and non pull cord window blinds. A pull-cord window blind uses a pull cord for pulling by a user to move the blind between an extended status and a received status. A non pull cord window blind allows a user uses his/her hand to pull down or push up a bottom rail, causing the blind to be moved between an extended status and a received status.

So far as the prior art techniques of non pull cord window blinds are concerned, U.S. Pat. No. 7,025,107 discloses a cordless window blind, which uses a one-way tensioning mechanism to control the movement of first and second cords. When extending out the window blind, the one-way tensioning mechanism is driven by the first and second cords to move to a release position, allowing the first and second cords to be freely moved. Once the window blind is stopped from being extended out, the one-way tensioning mechanism is driven by the first and second cords to move from the release position to an engaged position, prohibiting the first and second cords from being rolled up by the spool, and thus, the window blind is held in position. In this prior art patent, the actuation of the one-way tensioning mechanism is not optimally reliable, affecting the blind extending and receiving smoothness.

### SUMMARY OF THE INVENTION

The present invention has been accomplished under the circumstances in view. It is the main object of the present invention to provide a blind body brake mechanism for non pull cord window blind, which assures a high level of operating reliability and positioning accuracy, enhancing window blind operating smoothness.

To achieve this and other objects of the present invention, a blind body brake mechanism for non pull cord window blind comprises a rolling-up unit, two one-way clutch units, and two transmission cords. The rolling-up unit comprises a casing, two coil spring winding wheels, a coil spring, and two transmission cord take-up wheels. The coil spring winding wheels are rotatably mounted in the casing and meshed with each other. The coil spring is connected between the two coil spring winding wheels, and selectively wound around one coil spring winding wheel. The two transmission cord take-up wheels are rotatably mounted in the casing, and respectively meshed with one coil spring winding wheel. The two one-way clutch units are kept apart from the rolling-up unit at a predetermined distance respectively. Each the one-way clutch unit comprises a wheel axle holder, a clutch wheel axle, a clutch wheel, and at least two planetary gears. The clutch wheel axle is fixedly mounted in the wheel axle holder, comprising at least two brake blocks equiangularly spaced around the periphery of one end thereof and a rolling groove defined between each two adjacent brake blocks. The clutch wheel is rotatably mounted on the clutch wheel axle, comprising an internal gear surrounding the at least two brake blocks. Each planetary gear is rotatably mounted in one respective rolling groove of the clutch wheel axle and meshed with the internal gear of the clutch wheel, and drivable by the internal gear of the clutch wheel into engagement with one respective brake block or away therefrom. The two transmission cords are respectively wound around the clutch wheel, each having one end thereof fixedly connected to one respective transmission cord take-up wheel.

Thus, when the planetary gears are engaged with the respective brake blocks of the clutch wheel axle, the clutch wheel is prohibited from rotation. At this time, the blind body is held in position and prohibited from being extended out or received. When the planetary gears are disengaged from the respective brake blocks of the clutch wheel axle, the clutch wheel is freely rotatable, and at this time, the blind body can be extended out.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a blind body brake mechanism for non pull cord window blind in accordance with the present invention.

FIG. 2 is an exploded view of the rolling-up unit of the blind body brake mechanism for non pull cord window blind in accordance with the present invention.

FIG. 3 is an exploded view of the clutch unit of the blind body brake mechanism for non pull cord window blind in accordance with the present invention.

FIG. 4 is a sectional view of a part of the clutch unit of the blind body brake mechanism for non pull cord window blind in accordance with the present invention.

FIG. 5 is a schematic plain view illustrating the blind body brake mechanism used in a non pull cord window blind in accordance with the present invention.

FIG. 6 is a sectional view of a part of the non pull cord window blind shown in FIG. 5, illustrating the planetary gears respectively abutted against the bearing portions of the respective brake blocks during opening of the blind body.

FIG. 7 corresponds to FIG. 6, illustrating the blind body fully extended out and the planetary gears engaged with the brake portions of the respective brake blocks.

FIG. 8 is similar to FIG. 7, illustrating the blind body in the received status and the planetary gears respectively abutted against the bearing portions of the respective brake blocks.

### DETAILED DESCRIPTION OF THE INVENTION

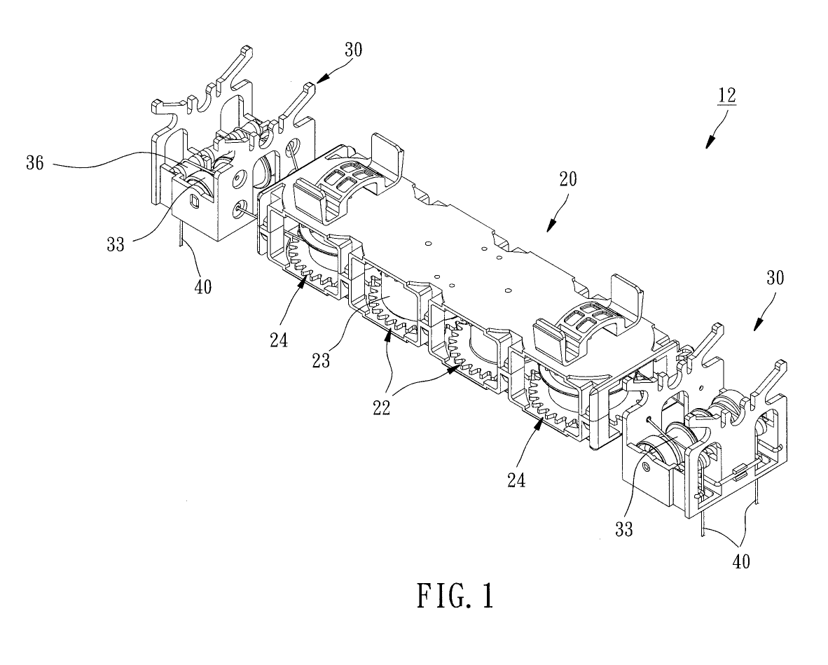

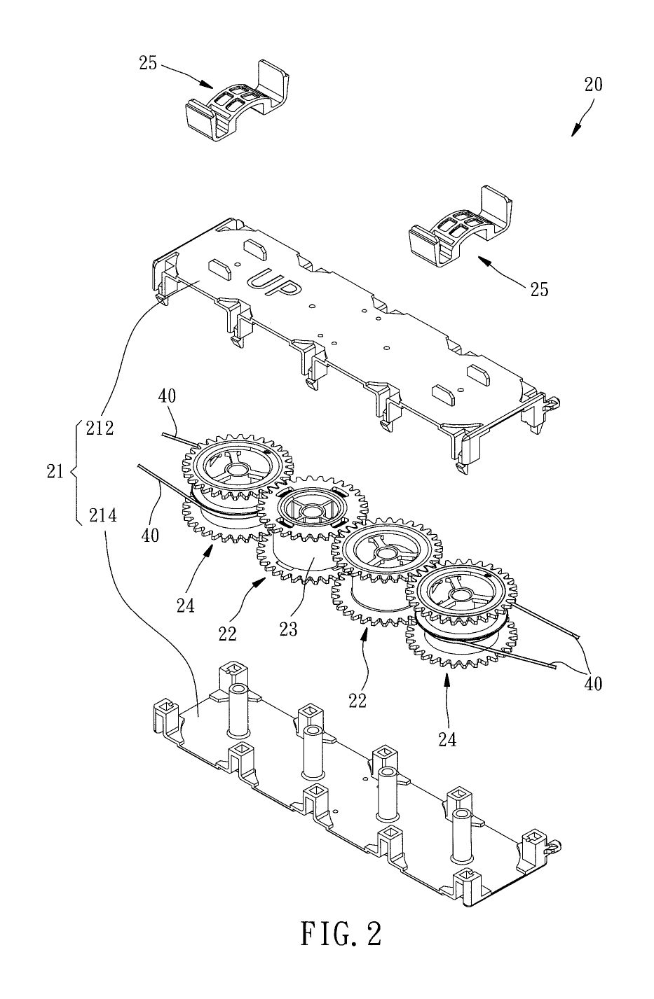

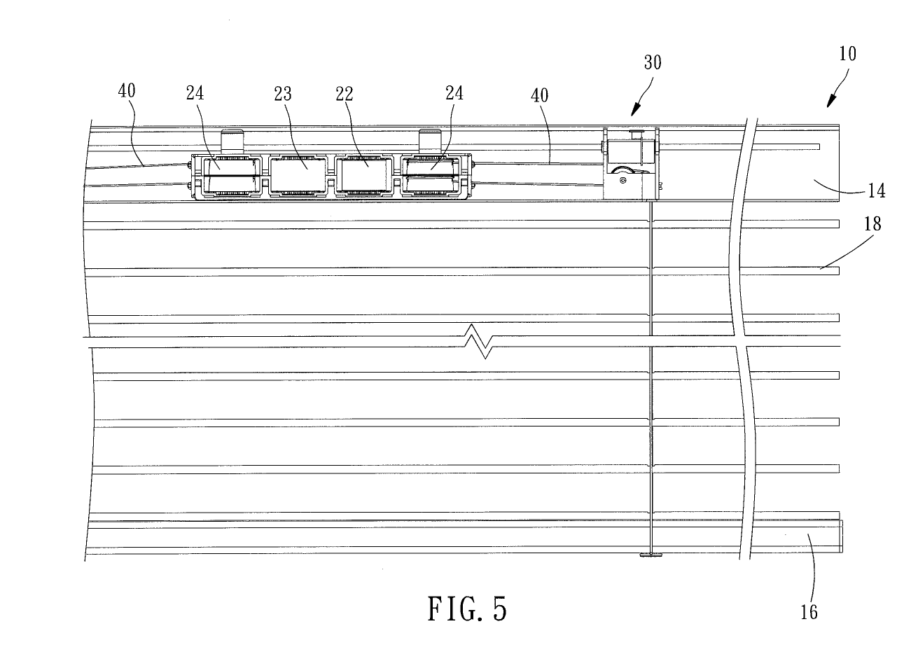

Referring to FIG. 5, a blind body brake mechanism 12 is used in a non pull cord window blind 10 in accordance with the present invention. As illustrated, the non pull cord window blind 10 comprises a top rail 14, an opposing bottom rail 16, and blind body 18 coupled between the top rail 14 and the bottom rail 16. Referring also to FIG. 1 and FIG. 2, the blind body brake mechanism 18 in accordance with the present invention is shown used in the aforesaid non pull cord comprises a rolling-up unit 20, two one-way clutch units 30, and two pairs of transmission cords 40.

As illustrated in FIG. 1 and FIG. 2, the rolling-up unit 20 comprises a casing 21, two coil spring winding wheels 22, a coil spring 23, and two transmission cord take-up wheels 24. The casing 21 comprises a top panel 212 and an opposing bottom panel 214. The two coil spring winding wheels 22 are rotatably mounted in the casing 21 and meshed together. The coil spring 23 has two opposite ends thereof respectively connected to the two coil spring winding wheels 22, enabling the two coil spring winding wheels 22 to be rotated synchronously. The transmission cord take-up wheels 24 are rotatably mounted in the casing 21 and respectively meshed with the coil spring winding wheels 22 for rotation with the respective coil spring winding wheels 22 synchronously. The rolling-up unit 20 further comprises two snap fasteners 25 mounted at a top wall of the top panel 212 of the casing 21 for fastening the casing 21 to the inside of the top rail 14 by snapping.

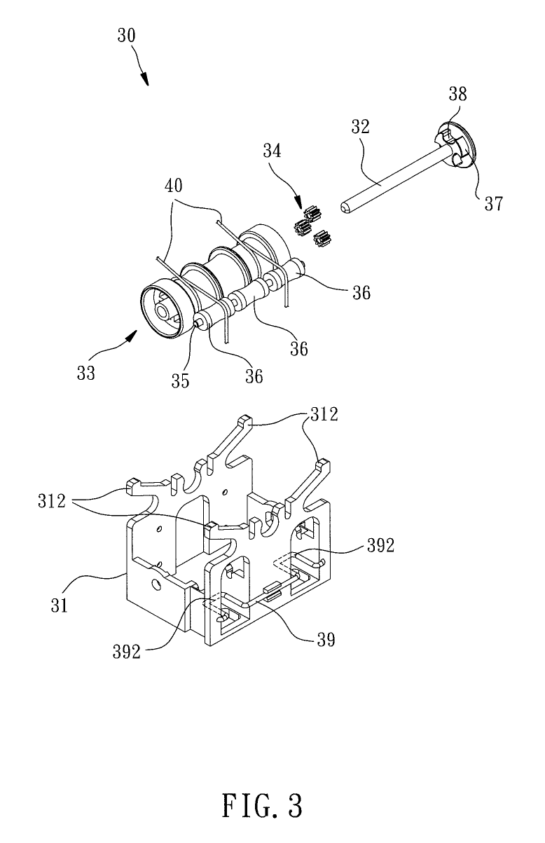

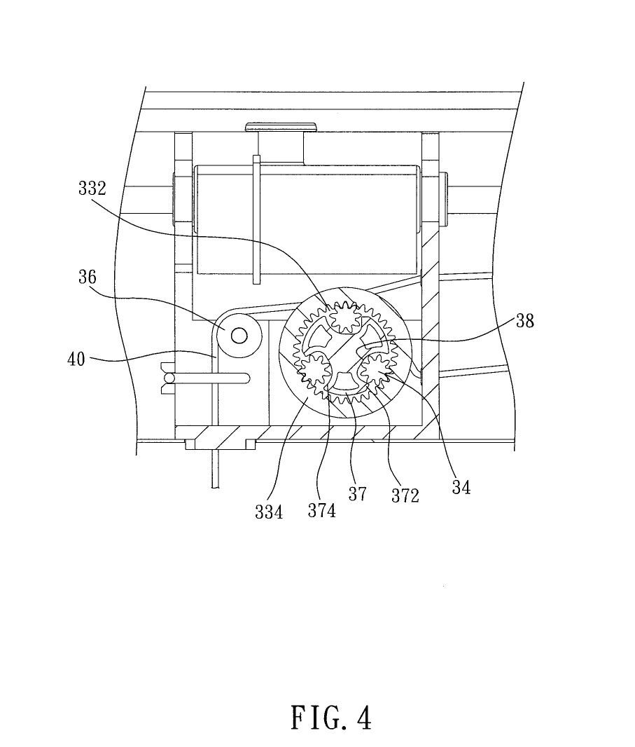

As illustrated in FIG. 1 and FIG. 3, each the one-way clutch unit 30 comprises a wheel axle holder 31, a clutch wheel axle 32, a clutch wheel 33, three planetary gears 34, a guide roller axle 35, and three guide rollers 36. The wheel axle holder 31 comprises four fastening portions 312. By means of the fastening portions 312, the wheel axle holder 31 is fastened to the inside of the top rail 14. The clutch wheel axle 32 has two opposite ends thereof affixed to the wheel axle holder 31. Further, the clutch wheel axle 32 comprises three brake blocks 37 located at one end thereof. As illustrated in FIG. 3 and FIG. 4, these three brake blocks 37 are equiangularly spaced around the periphery of one end of the clutch wheel axle 32 so that a rolling groove 38 is defined between each two adjacent brake blocks 37. As illustrated in FIG. 4, the curvature of one end of the rolling groove 38 is larger than the curvature of an opposite end of the rolling groove 38. Because the two opposite ends of each rolling groove 38 are respectively abutted to a different brake block 37 so that subject to the curvature difference between the two opposite ends of each rolling groove 38, each brake block 37 has two opposite ends thereof respectively terminating in a brake portion 372 and a bearing portion 374, wherein the curvature of the brake portion 372 is larger than the curvature of the bearing portion 374. The clutch wheel 33 comprises an axle hole 332, and an internal gear 334 disposed adjacent to the axle hole 332. The clutch wheel 33 is sleeved onto the clutch wheel axle 32 by means of the axle hole 332. After the clutch wheel 33 is sleeved onto the clutch wheel axle 32, the internal gear 334 is kept surrounding the brake blocks 37. The planetary gears 34 are respectively mounted in the rolling grooves 38 and meshed with the internal gear 334 of the clutch wheel 33 so that when the clutch wheel 33 is being rotated, the planetary gears 34 can be driven by the internal gear 334 of the clutch wheel 33 to rotate in the respective rolling grooves 38. The guide roller axle 35 is fixedly mounted in the wheel axle holder 31 in parallel to the clutch wheel axle 32. The guide rollers 36 are rotatably mounted on the guide roller axle 35. Further, the roller diameter of the guide rollers 36 is smaller than the wheel diameter of the clutch wheel 33.

The two transmission cords 40 of each pair of transmission cords 40 are respectively arranged at opposing front and back sides relative to the clutch wheel 33 and then wound around the clutch wheel 33 through one turn, and then respectively wound around one guide roller 36 with the two opposite ends thereof respectively affixed to the bottom rail 16 and the transmission cord take-up wheel 24.

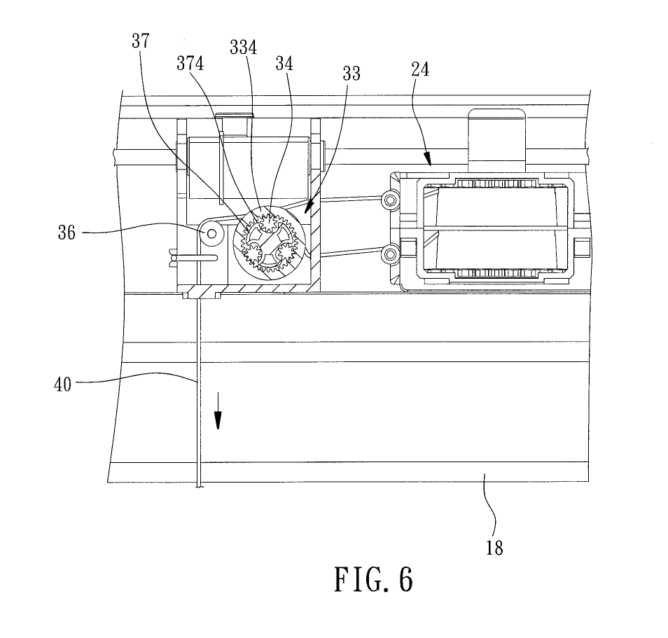

When wishing to extend out the blind body 18, as shown in FIGS. 1, 3, 4 and 6, pull the bottom rail 16 downwards to drag the transmission cords 40 out of the respective transmission cord take-up wheels 24. In the process the transmission cords 40 are dragged, the transmission cord take-up wheels 24 are driven to rotate. During rotation of the transmission cord take-up wheels 24, the meshed coil spring winding wheels 22 are driven to rotate, causing the coil spring 23 to be wound up from one coil spring winding wheel 22 onto the other coil spring winding wheel 22 to accumulate a suitable amount of elastic potential energy.

On the other hand, when the transmission cords 40 are being dragged, the friction resistance between the transmission cords 40 and the clutch wheel 33 and the friction resistance between the transmission cords 40 and the guide rollers 36 drive the clutch wheel 33 and the guide rollers 36 to rotate. When rotating the clutch wheel 33, the planetary gears 34 are driven by the internal gear 334 to move along the respective rolling grooves 38 to the bearing portions 374 of the respective brake blocks 37. At this time, the planetary gears 34 run idle, enabling the clutch wheel 33 to be freely rotated so that the blind body 18 can be continuously extended out. Further, when the transmission cords 40 are being dragged, rotation of the guide rollers 36 enables the transmission cords 40 to maintain a certain level of tension.

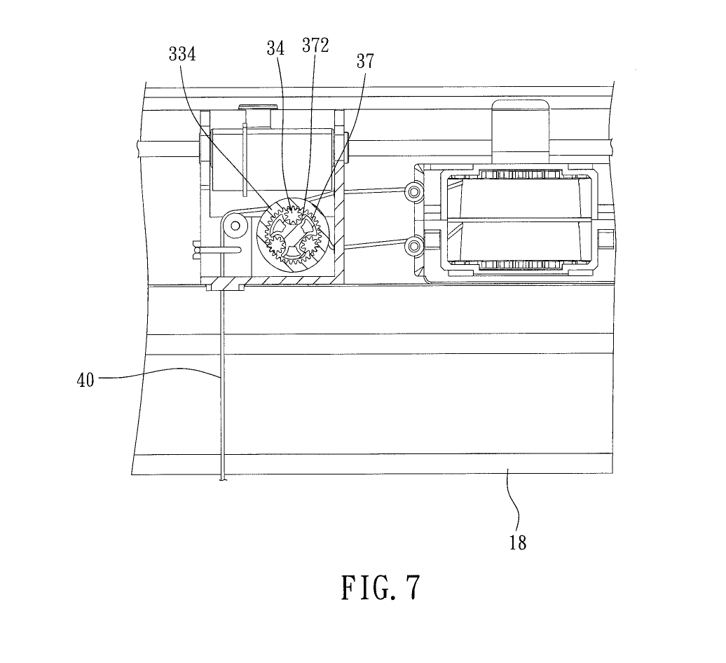

When the user releases the hand from the bottom rail 16 to stop from dragging the transmission cords 40 after the blind body 18 reached the desired extended position, at this time, the coil spring winding wheel 22 is forced by the elastic potential energy of the coil spring 23 to reverse the transmission cord take-up wheels 24 slightly. During reverse rotation of the transmission cord take-up wheels 24, the transmission cord take-up wheels 24 roll up a small part of the respective transmission cords 40, causing the clutch wheel 33 to be reversed slightly by the transmission cords 40. During reverse rotation of the clutch wheel 33, the internal gears 334 are forced to move the planetary gears 34 along the respective rolling grooves 38 into engagement with the brake portions 372 of the respective brake blocks 37, as shown in FIG. 7, and thus, the planetary gears 34 are stopped from rotation, and the clutch wheel 33 is also stopped from rotation. At this time, the transmission cords 40 are kept in static balance subject to the effects of the elastic potential energy of the coil spring 23, the effects of the friction resistance between the transmission cords 40 and the clutch wheel 33 and the gravity weight of the bottom rail 16, and thus, the blind body 18 is held in position.

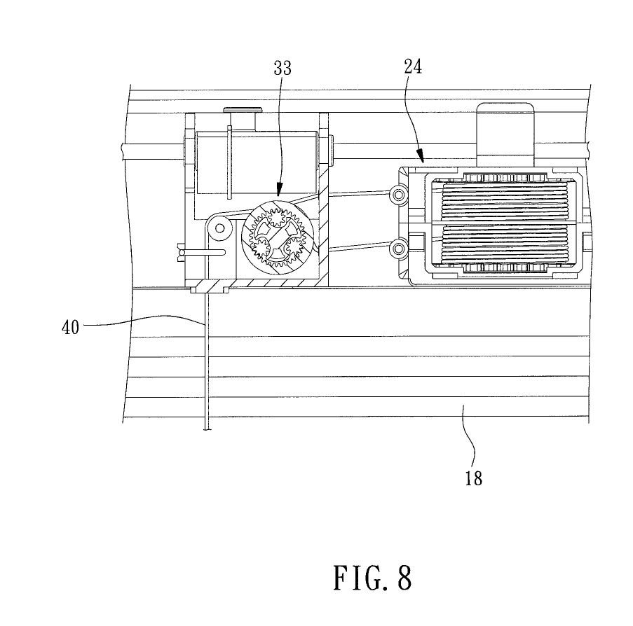

When wishing to receive the blind body 18, as shown in FIGS. 1, 3 and 8, apply an upward force to lift the bottom rail 16 and to further loosen the transmission cords 40, thereby lowering the friction resistance between the transmission cords 40 and the clutch wheel 33. At this time, the elastic potential energy of the coil spring 23 forces the coil spring winding wheels 22 to rotate. During rotation of the coil spring winding wheels 22, the transmission cord take-up wheels 24 are rotated by the coil spring winding wheels 22 to roll up the respective transmission cords 40. During rotation of the transmission cord take-up wheels 24 to roll up the respective transmission cords 40, the clutch wheel 33 is kept immovable. As soon as the blind body 18 reaches the desired position, release the lifting force from the bottom rail 16, enabling the transmission cords 40 to be wound around the clutch wheel 33 tightly. At this time, the elastic potential energy of the coil spring 23 is maintained in static balance with the gravity weight of the bottom rail 16 and the friction resistance between the transmission cords 40 and the clutch wheel 33, and thus, the blind body 18 is held in position.

It is to be noted that the rolling-up unit 20 uses the snap fasteners 25 for mounting in the top rail 14. When compared to the convention mounting techniques (such as the use of screws), the invention enhances installation convenience. Further, after installation in the top rail 14, the one-way clutch units 30 are kept away from the rolling-up unit 20 at a predetermined distance respectively. This predetermined distance is determined subject to the size of the window blind. For example, this predetermined distance must be relatively increased if the size of the window blind is relatively larger, enabling the one-way clutch units 30 to achieve optimal transmission effects. On the other hand, the number of the transmission cords 40 can be adjusted according to the size of the window blind. In the present preferred embodiment, two pairs of transmission cords 40 are arranged, however, in actual application, two transmission cords 40, which wound around the clutch wheels 33 respectively, are sufficient for a small window blind. In this case, one single guide roller 36 can be arranged to achieve the desired effects. Further, in order for enabling the transmission cords 40 to maintain stable during actuation, the one-way clutch unit 30 provides two resilient retainers 39 respectively mounted in the wheel axle holder 31, each comprising two retaining portions 392 respectively extending around one respective transmission cord 40, enabling each transmission cord 40 to be kept in a constrained position.

In conclusion, the one-way clutch unit 30 provided by the blind body brake mechanism 12 of the present invention utilizes the mating relationship among the brake blocks 37 of the clutch wheel axle 32, the internal gears 334 of the clutch wheel 33 and the planetary gears 34 to provide the blind body 18 with an optimal positioning effect, enhancing operating stability and actuating accuracy, and, assuring a high level of smoothness during the operation of extending out or receiving the blind body 18.

What is claimed is:

1. A blind body brake mechanism for non pull cord window blind, comprising:
a rolling-up unit comprising a casing, two coil spring winding wheels, a coil spring and two transmission cord take-up wheels, said coil spring winding wheels being rotatably mounted in said casing and meshed with each other, said coil spring being connected between said two coil spring winding wheels and selectively wound around one said coil spring winding wheel, said two transmission cord take-up wheels being rotatably mounted in said casing and respectively meshed with one respective said coil spring winding wheel;
two one-way clutch units kept apart from said rolling-up unit at a predetermined distance respectively, each said one-way clutch unit comprising a wheel axle holder, a clutch wheel axle, a clutch wheel and at least two planetary gears, said clutch wheel axle being fixedly mounted in said wheel axle holder, said clutch wheel axle comprising at least two brake blocks equiangularly spaced around the periphery of one end thereof and a rolling groove defined between each two adjacent said brake blocks, said clutch wheel being rotatably mounted on said clutch wheel axle, said clutch wheel comprising an internal gear surrounding said at least two brake blocks, each said planetary gear being rotatably mounted in one respective said rolling groove of said clutch wheel axle and meshed with said internal gear of said clutch wheel and drivable by said internal gear of said clutch wheel into engagement with one respective said brake block or away therefrom; and
two transmission cords respectively wound around said clutch wheels, each said transmission cord having one end thereof fixedly connected to one respective said transmission cord take-up wheel.

2. The blind body brake mechanism for non pull cord window blind as claimed in claim 1, wherein the curvature of one end of each said rolling groove is larger than the curvature of an opposite end of each said rolling groove so that each said brake block has two opposite ends thereof respectively terminating in a brake portion and a bearing portion, the curvature of said brake portion being larger than the curvature of said bearing portion; said clutch wheel is prohibited from rotation when each said planetary gear is forced into engagement with the brake portion of one respective said brake block; said clutch wheel is freely rotatable when each said planetary gear is forced into abutment against the bearing portion of one respective said brake block.

3. The blind body brake mechanism for non pull cord window blind as claimed in claim 1, wherein said one-way clutch unit further comprises a guide roller axle and a guide roller, said guide roller axle being fixedly mounted in said wheel axle holder, said guide roller being rotatably mounted on said guide roller axle and surrounded by one said transmission cord.

4. The blind body brake mechanism for non pull cord window blind as claimed in claim 3, wherein the diameter of said guide roller is smaller than the diameter of said clutch wheel.

5. The blind body brake mechanism for non pull cord window blind as claimed in claim 1, wherein said rolling-up unit further comprises a snap fastener located at a top side of said casing.

6. The blind body brake mechanism for non pull cord window blind as claimed in claim 1, wherein said one-way clutch unit further comprises a resilient retainer mounted in said wheel axle holder, said resilient retainer comprising a retaining portion extending around one respective said transmission cord.
